(19) United States
(12) Patent Application Publication
(10) Pub. No.: US 2016/0350951 A1
(43) Pub. Date: Dec. 1, 2016

(54) CHART DRAWING METHOD

(71) Applicants: Chieh-Yu Chan, Taipei City (TW); Ming-Che Weng, Taipei City (TW); Ji-Hong Huang, Taipei City (TW); Chia-Ni Chen, Taipei City (TW)

(72) Inventors: Chieh-Yu Chan, Taipei City (TW); Ming-Che Weng, Taipei City (TW); Ji-Hong Huang, Taipei City (TW); Chia-Ni Chen, Taipei City (TW)

(73) Assignee: COMPAL ELECTRONICS, INC., Taipei City (TW)

(21) Appl. No.: 14/985,464

(22) Filed: Dec. 31, 2015

(30) Foreign Application Priority Data
May 27, 2015 (TW) 104117005

(51) Int. Cl. G06T 11/20; G06F 17/24; G06F 3/0484; G06T 11/60; G06F 3/0482

(52) U.S. Cl. CPC G06T 11/206; G06T 11/60; G06F 3/0482; G06F 3/04842; G06F 17/242; G06T 2200/24

(57) ABSTRACT

A chart drawing method for an electronic device is provided. The chart drawing method includes receiving a drawing instruction, and enabling a drawing operation according to the drawing instruction; receiving a first hand-painted trajectory, and recognizing whether the first hand-painted trajectory matches a predefined chart type; when the first hand-painted trajectory matches the predefined chart type, displaying a chart corresponding to the predefined chart type, and clearing the first hand-painted trajectory; and receiving a second hand-painted trajectory, and dividing the chart into a plurality of areas according to the second hand-painted trajectory. Accordingly, users can draw the chart in an intuitive and convenient manner.

### CROSS-REFERENCE TO RELATED APPLICATION

This application claims the priority benefit of Taiwan application serial no. 104117005, filed on May 27, 2015. The entirety of the above-mentioned patent application is hereby incorporated by reference herein and made a part of this specification.

### BACKGROUND OF THE INVENTION

Field of the Invention

The invention relates to a chart drawing method, and more particularly, to a chart drawing method performed by hand-painting in an electronic device.

Description of Related Art

With advancements in technology, paper data have been gradually replaced by electronic data. The electronic data is easy to store and convenient to carry around, and can be easily searched as compared to the paper data. Users may take important notes simply by using an electronic device (e.g., a tablet computer) having an electronic notebook function instead of a traditional notebook. However, when the electronic notebook is used for chart drawing, because contents recorded in a hand-painted manner are stored in form of image files, which are inconvenient for users to edit or modify the recorded contents. Accordingly, it is one of important topics in the industry as how to improve a drawing chart method for the electronic notebook.

### SUMMARY OF THE INVENTION

The invention is directed to a chart drawing method which allows users to draw various charts in a hand-painted manner in an electronic device, and the drawn charts may be converted into digitized contents for users to edit and modify the drawn charts.

The chart drawing method of the invention is suitable for an electronic device. The chart drawing method includes receiving a drawing instruction, and enabling a drawing operation according to the drawing instruction; receiving a first hand-painted trajectory, and recognizing whether the first hand-painted trajectory matches a predefined chart type; when the first hand-painted trajectory matches the predefined chart type, displaying a chart corresponding to the predefined chart type, and clearing the first hand-painted trajectory; and receiving a second hand-painted trajectory, and dividing the chart into a plurality of areas according to the second hand-painted trajectory.

In an embodiment of the invention, the chart drawing method further includes: calculating a proportion of each of the areas in the chart, and displaying a text message corresponding to the proportion in each corresponding one of the areas.

In an embodiment of the invention, the chart drawing method further includes: changing a proportion of each of the areas in the chart according to an adjusting instruction, and re-displaying the chart.

In an embodiment of the invention, after the step of recognizing whether the first hand-painted trajectory matches the predefined chart type, the chart drawing method further includes: displaying a chart menu when there is no predefined chart type corresponding to the first hand-painted trajectory, wherein the chart menu comprises one or more chart options; receiving a user selection to select one of the chart options; and displaying the chart according to the selected chart option, and clearing the first hand-painted trajectory.

In an embodiment of the invention, a dimension of the chart is determined according to the first hand-painted trajectory.

In an embodiment of the invention, the predefined chart type corresponding to the first hand-painted trajectory is a circle, and the chart corresponding to the circle is a pie chart. Accordingly, the step of displaying the chart corresponding to the predefined chart type further includes: calculating a length of a maximum chord of the first hand-painted trajectory, and drawing the chart by using a center point of the first hand-painted trajectory as a circle center and a half of the length of the maximum chord as a radius.

In an embodiment of the invention, after the step of dividing the chart into the areas according to the second hand-painted trajectory, the chart drawing method further includes: receiving a hand-written value, and recognizing the hand-written value as a digitized text; and adjusting sizes of the areas according to the digitized text.

In an embodiment of the invention, the step of dividing the chart into the areas according to the second hand-painted trajectory further includes: when the second hand-painted trajectory is located within the chart and the second hand-painted trajectory is a line-segment, determining whether a distance between two ends of the line-segment is greater than the radius; if the distance between the two ends of the line-segment is greater than the radius, displaying a straight line in the chart according to a location of the second hand-painted trajectory to divide the chart by the straight line, and clearing the second hand-painted trajectory; and if the distance between the two ends of the line-segment is not greater than the radius, directly clearing the second hand-painted trajectory.

In an embodiment of the invention, the predefined chart type corresponding to the first hand-painted trajectory is a rectangle, and the chart corresponding to the rectangle is a table. Accordingly, the step of displaying the chart corresponding to the predefined chart type further includes: calculating a length of a horizontal edge and a length of a vertical edge of the first hand-painted trajectory, and drawing the chart according to the length of the horizontal length and the length of the vertical edge. Herein, the horizontal edge is intersected with the vertical edge.

In an embodiment of the invention, the step of dividing the chart into the areas according to the second hand-painted trajectory further includes: when the second hand-painted trajectory is located within the chart and the second hand-painted trajectory is a horizontal line-segment, determining whether a length of the horizontal line-segment is greater than a half of the length of the horizontal edge of the chart; if the length of the horizontal line-segment is greater than the half of the length of the horizontal edge of the chart, displaying a horizontal grid line in the chart according to a location of the second hand-painted trajectory to thereby divide the chart, and clearing the second hand-painted trajectory; if the length of the horizontal line-segment is not greater than the half of the length of the horizontal edge of the chart, directly clearing the second hand-painted trajectory; when the second hand-painted trajectory is located within the chart and the second hand-painted trajectory is a vertical line-segment, determining whether a length of the vertical line-segment is greater than a half of the length of the vertical edge; if the length of the vertical line-segment is greater than the half of the length of the vertical edge of the chart, displaying a vertical grid line in the chart according to the location of the second hand-painted trajectory to thereby divide the chart, and clearing the second hand-painted trajectory; and if the length of the vertical line-segment is not greater than the half of the length of the vertical edge of the chart, directly clearing the second hand-painted trajectory.

In an embodiment of the invention, the predefined chart type corresponding to the first hand-painted trajectory is a triangle, and the chart corresponding to the triangle is a pyramid chart. Accordingly, the step of displaying the chart corresponding to the predefined chart type further includes: calculating a length of a bottom side of the first hand-painted trajectory, calculating a vertex relative to the bottom side in the first hand-painted trajectory, and drawing the chart by using the bottom side and the vertex.

Based on the above, in the chart drawing method of the disclosure, a digitized chart may be drawn by receiving the drawing instruction of the user, recognizing the hand-painted trajectory of the user, and comparing the hand-painted trajectory with the predefined chart type. As a result, users can draw the chart in an intuitive and convenient manner.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the invention.

FIG. 2 is a flowchart illustrating a chart drawing method according to an embodiment of the invention.

FIG. 3 is a schematic diagram illustrating an electronic note interface according to an embodiment of the invention.

FIG. 4A to FIG. 4C are schematic diagrams illustrating hand-painted trajectories according to an embodiment of the invention.

FIG. 5A to FIG. 5D are schematic diagrams illustrating a chart drawing method according to an embodiment of the invention.

FIG. 6A and FIG. 6B are schematic diagrams illustrating a chart drawing method according to an embodiment of the invention.

FIG. 7A and FIG. 7B are schematic diagrams illustrating a chart drawing method according to an embodiment of the invention.

FIG. 8 is a schematic diagram illustrating a pie chart drawing method according to an embodiment of the invention.

FIG. 9A and FIG. 9B are schematic diagrams illustrating a pie chart drawing method according to an embodiment of the invention.

FIG. 10A and FIG. 10B are schematic diagrams illustrating a pie chart drawing method according to an embodiment of the invention.

FIG. 11 is a schematic diagram illustrating a table drawing method according to an embodiment of the invention.

FIG. 12A to FIG. 12D are schematic diagrams illustrating a table drawing method according to an embodiment of the invention.

FIG. 13 is a schematic diagram illustrating a pyramid chart drawing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

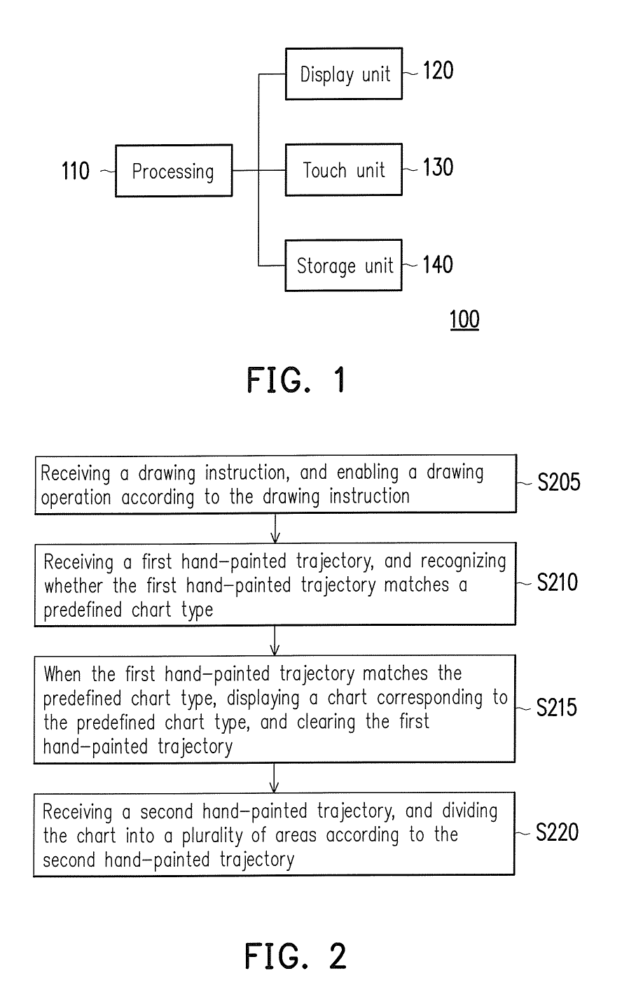

FIG. 1 is a block diagram illustrating an electronic device according to an embodiment of the invention. Referring to FIG. 1, an electronic device 100 is, for example, consumer electronics such as a cell phone, a tablet computer, a notebook computer or a desktop computer. The electronic device 100 at least includes a processing unit 110, a display unit 120, a touch unit 130 and a storage unit 140.

The processing unit 110 is coupled to the display unit 120, the touch unit 130 and the storage unit 140. The processing unit 110 is, for example, a central processing unit (CPU), a programmable microprocessor, or an embedded control chip and the like.

The display unit 120 is, for example, a cathode ray tube (CRT) display, a liquid crystal display (LCD), a plasma display or the like.

The touch unit 130 may include a touch panel, a touch button and/or a touch roller, and may be implemented by various touch sensing technologies such as a resistive type, a capacitive type, an optical type, an acoustic wave type, an electromagnetic type and the like, but a type of the touch unit 130 is not limited to the above. For example, a user may click or slide on the touch unit 130 by using fingers, a stylus or various input devices in order to generate an input signal.

Further, the display unit 120 and the touch unit 130 may also be integrated as a touch screen. The touch screen is, for example, a screen that includes touch control functions (e.g., a resistive type touch screen, a capacitive type touch screen, a wave type touch screen, etc.) or a screen combined with other elements to include the touch control functions.

The storage unit 140 is, for example, a fixed or a movable device in any possible foil is including a random access memory (RAM), a read-only memory (ROM), a flash memory, a hard drive or other similar devices, or a combination of the above-mentioned devices. Herein, a computer program product is stored in the storage unit 140. Basically, the computer program product is assembled by a plurality of program sections (i.e. building an organization diagram program section, approving a list program section, setting a program section, and deploying a program section). Moreover, after the program sections are loaded and executed by the electronic device 100, the chart drawing method as described below may be executed by the processing unit 110.

FIG. 2 is a flowchart illustrating a chart drawing method according to an embodiment of the invention. In the present embodiment, when the user starts the computer program product for using the electronic note in the electronic device 100, the processing unit 110 starts to execute the following flows based on an operation instruction of the user.

Referring to FIG. 2, in step S205, the processing unit 110 receives a drawing instruction, and enables a drawing operation according to the drawing instruction. Specifically, the drawing instruction is, for example, generated by clicking on an icon or an option in an electronic notebook interface by the user. Further, the drawing instruction may also be generated according to a specific gesture of the user. The processing unit 110 may enable the drawing operation according to the drawing instruction.

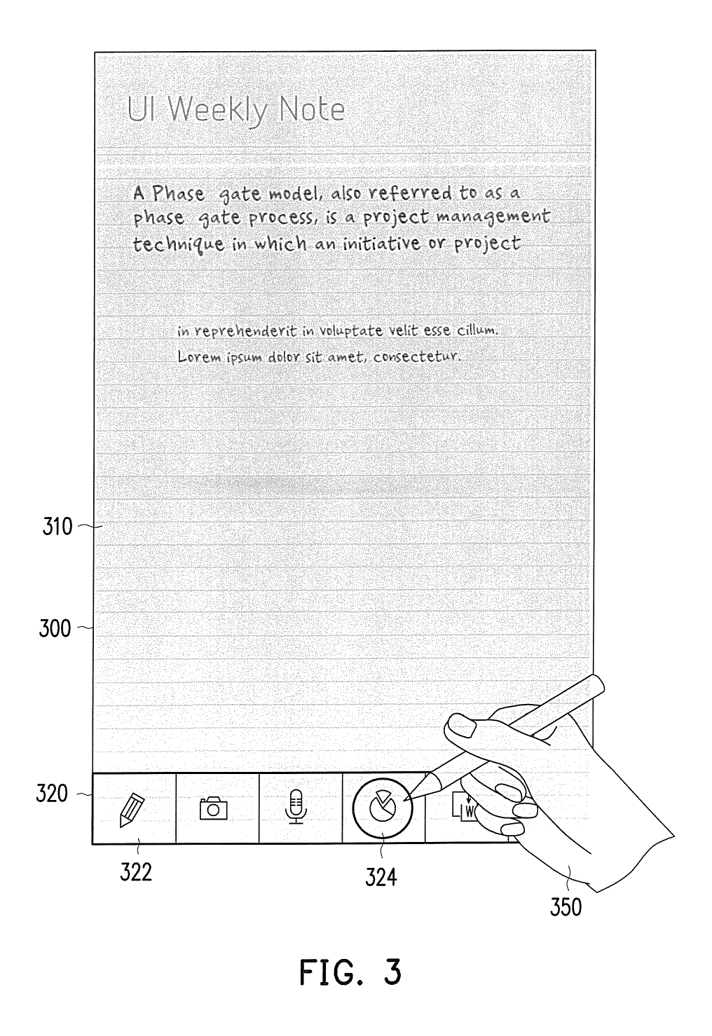

For instance, FIG. 3 is a schematic diagram illustrating an electronic note interface according to an embodiment of the invention. Referring to FIG. 3, the present embodiment is applied in the electronic device including the touch screen, and an electronic note interface 300 is installed in the electronic device 100. A display area of the electronic note interface 300 includes an edit area 310 and a tool bar 320. The tool bar 320 lists icons representing various function modes provided by the electronic note interface 300, such as an icon 322 representing a hand-writing input function mode and an icon 324 representing a chart drawing function mode. In the present embodiment, a user 350 may click on the icon 322 representing the hand-writing input function mode in the tool bar 320 to enable a hand-writing input function, and then input text in a hand-writing manner in the edit area 310. When the user 350 intends to insert a chart in the edit area 310, the user may click on the icon 324 representing the chart drawing function mode in the tool bar 320 in order to generate the drawing instruction. After the drawing instruction is received, the processing unit 110 may enable the drawing operation according to the drawing instruction, so that the user 350 may insert the chart in the edit area 310 of the electronic note interface 300 and edit the chart. After the chart is edited, the user 350 may click on the icon 324 representing the chart drawing function mode in the tool bar 320 again to close the chart drawing function mode. Further, it is possible that the drawing operation is not performed in an additional window, the user may see the chart under editing and a text message already inputted in the edit area 310. The edited chart and the electronic note document may be stored in the storage unit 140.

Referring back to FIG. 2, in step S210, after the drawing operation is enabled, the processing unit 110 may receive a hand-painted trajectory (a first hand-painted trajectory) of the user, and recognize whether the first hand-painted trajectory matches a predefined chart type. Specifically, the hand-painted trajectory of the user may be a consecutive trajectory in one stroke, and a start point and an end point of the hand-painted trajectory do not need to be the same. The hand-painted trajectory may be a nearly-closed graph but does not have to be a totally enclosed graph. The processing unit 110 may further recognize whether the first hand-painted trajectory matches the predefined chart type. The predefined chart type is, for example, a circle, a triangle and a rectangle, and their corresponding charts are a pie chart, a pyramid chart and a table, respectively.

In step S215, when the first hand-painted trajectory matches the predefined chart type, the processing unit 110 displays a chart corresponding to the predefined chart type in the display unit 120, and clears the first hand-painted trajectory. For example, when it is recognized that the first hand-painted trajectory matches the circle, the processing unit 110 displays a pie chart frame corresponding to the predefined chart type in the display unit 120, and clears the first hand-painted trajectory. As another example, when it is recognized that the first hand-painted trajectory matches the rectangle, the processing unit 110 displays a table frame corresponding to the predefined chart type in the display unit 120, and clears the first hand-painted trajectory. As yet another example, when it is recognized that the first hand-painted trajectory matches the triangle, the processing unit 110 displays a pyramid chart frame corresponding to the predefined chart type in the display unit 120, and clears the first hand-painted trajectory.

Specifically, the processing unit 110 may determine the chart type that the user wants to draw according to the hand-painted trajectory of the user. For example, while drawing the pie chart, a circular frame is the first to be drawn. For example, while drawing the table, a rectangular frame is the first to be drawn. As another example, while drawing the pyramid chart, a triangular frame is the first to be drawn. Accordingly, the processing unit 110 compares the received first hand-painted trajectory with the predefined chart type after receiving the first hand-painted trajectory of the user, and then recognizes the predefined chart type that is proximate to the first hand-painted trajectory.

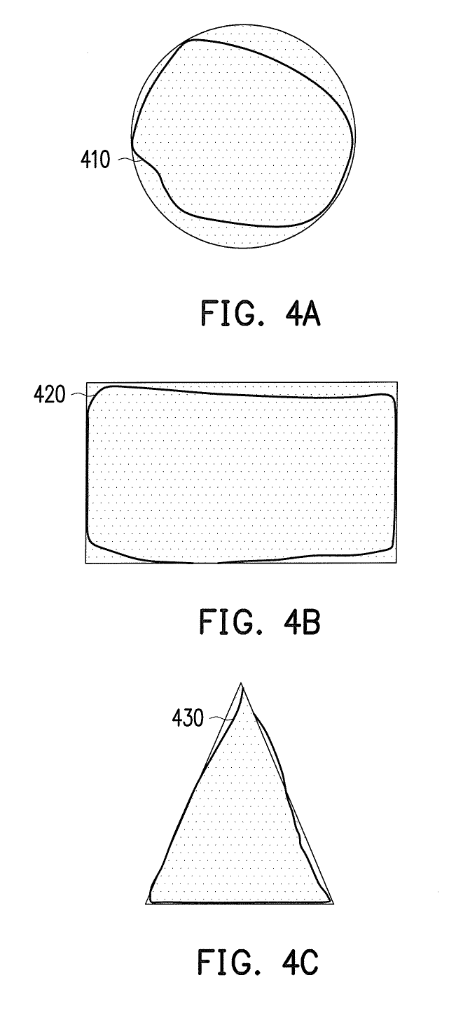

FIG. 4A to FIG. 4C are schematic diagrams illustrating hand-painted trajectories according to an embodiment of the invention. FIG. 4A is a circle drawn by the user with a hand-painted trajectory 410, and the processing unit 110 may recognize the predefined chart type proximate to the hand-painted trajectory 410 in FIG. 4A as the circle and the corresponding chart as the pie chart. FIG. 4B is a rectangle drawn by the user with a hand-painted trajectory 420, and the processing unit 110 may recognize the predefined chart type proximate to the hand-painted trajectory 420 in FIG. 4B as the rectangle and the corresponding chart as the table. FIG. 4C is a triangle drawn by the user with a hand-painted trajectory 430, and the processing unit 110 may recognize the predefined chart type proximate to the hand-painted trajectory 430 in FIG. 4C as the triangle and the corresponding chart as the pyramid chart.

Lastly, when the first hand-painted trajectory matches the predefined chart type, the processing unit 110 displays the chart corresponding to the predefined chart type in the display unit 120, and clears the first hand-painted trajectory.

In addition, when the first hand-painted trajectory does not have the corresponding predefined chart type, a chart menu is displayed in the display unit 120 for the user to select one chart option from the chart menu. The chart menu includes one or more chart options. For example, the chart menu include the chart options of the pie chart, the pyramid chart, the table, a bar chart, but contents of the chart options are not limited to the above. The user selects one chart option from among the chart options, such that after the chart option selected by the user is received, the processing unit 110 may display the corresponding chart in the display unit 120 according to the selected chart option and clear the first hand-painted trajectory.

Referring back to FIG. 2, in step S220, the processing unit 110 receives a second hand-painted trajectory, and divides the chart into a plurality of areas according to the second hand-painted trajectory. Specifically, the second hand-painted trajectory may include a plurality of line-segments, and the line-segments may divide the chart into the areas. Details regarding the above are provided below with reference to the following embodiments.

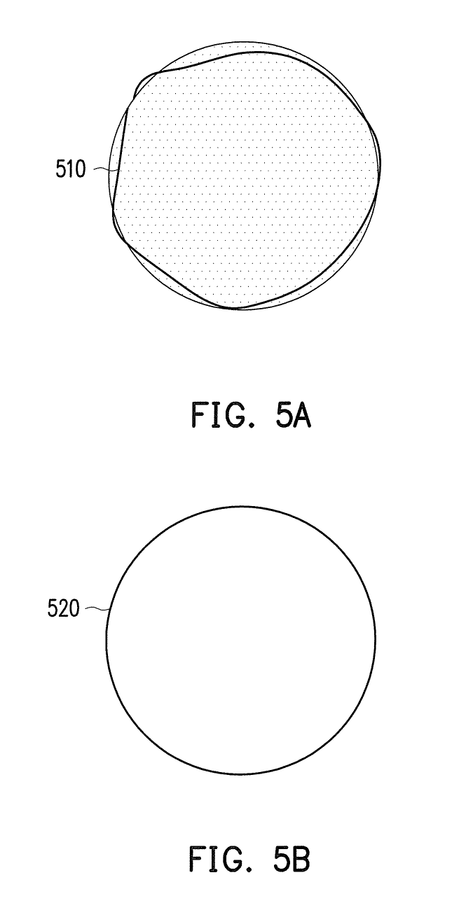

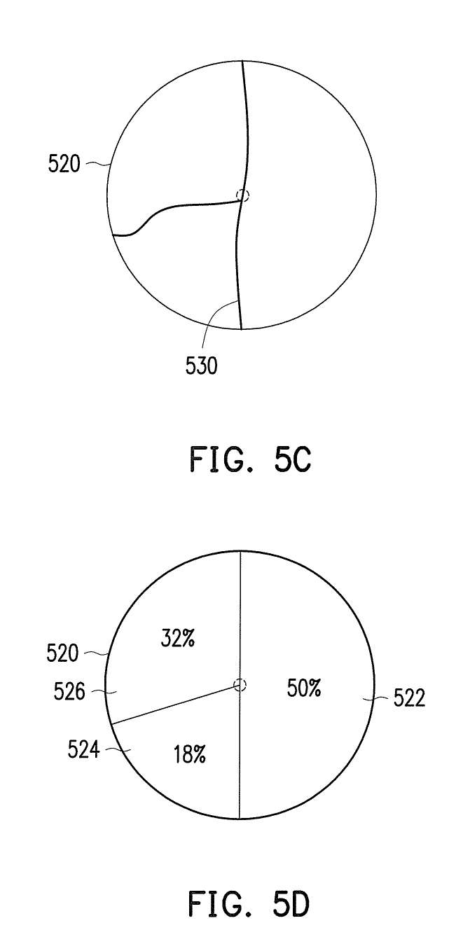

FIG. 5A to FIG. 5D are schematic diagrams illustrating a chart drawing method according to an embodiment of the invention. In the present embodiment, the chart that the user wants to draw is the pie chart. Referring to FIG. 5A, first of all, after the drawing operation of the electronic note interface 300 is enabled, the user may begin to draw the chart and generate a hand-painted trajectory (the first hand-painted trajectory) 510. The processing unit 110 receives the hand-painted trajectory 510 of the user, and recognizes that the predefined chart type matched to the hand-painted trajectory 510 is the circle, and the corresponding chart is the pie chart.

Referring to FIG. 5B, after recognizing that the predefined chart type matching the hand-painted trajectory 510 is the circle, the processing unit 110 displays a chart 520 corresponding to the predefined chart type matched to the hand-painted trajectory 510 in the display unit 120, i.e. displaying a frame of the pie chart in the display unit 120, and clears the hand-painted trajectory 510.

Referring to FIG. 5C, the user draws a line-segment (i.e., a hand-painted trajectory (the second hand-painted trajectory) 530) within the pie chart. The hand-painted trajectory 530 includes one or more line-segments for dividing the chart 520 into a plurality of areas.

Referring to FIG. 5D, the processing unit 110 receives the hand-painted trajectory 530, draws digitized line-segments in the chart 520 according to the hand-painted trajectory 530 so as to divide the chart 520 into an area 522, an area 524 and an area 526, and clears the hand-painted trajectory 530. It should be noted that, the processing unit 110 may regard a continuous and uninterrupted hand-painted trajectory of the user as one hand-painted trajectory. The processing unit 110 may instantly convert the hand-painted trajectory received each time into a digitized graph and clear the hand-painted trajectory, so that the user is able to perform the chart drawing intuitively.

In addition, the processing unit 110 may calculate a proportion of each of the areas in the chart, and displays a text message corresponding to the proportion of each of the areas in the chart in each corresponding one of the areas in the display unit 120. As shown in FIG. 5D, the processing unit 110 may automatically calculate the proportion of the area 524 in the chart 520 being 18%, and display the text message “18%” in the area 524 in the display unit 120. The rest of the areas in the chart 520 may be deduced by analogy.

In addition, the processing unit 110 may change the proportion of each of the areas in the chart according to an adjusting instruction, and re-display the chart in the display unit 120. Specifically, the user may click on the text message in a specific area, so that the text message is in a selected state to trigger the adjusting instruction. Subsequently, the user writes a number down by using the hand-painted trajectory for representing a new proportion of the specific area. The processing unit 110 receives the hand-painted trajectory as the adjusting instruction, so that the processing unit 110 may recognize and convert the hand-painted trajectory into a digitized text. The processing unit 110 may calculate the proportion of each of the areas in the chart according to the text recognized according to the hand-painted trajectory, and re-display the chart in the display unit 120. This will be discussed below with reference to the following embodiment.

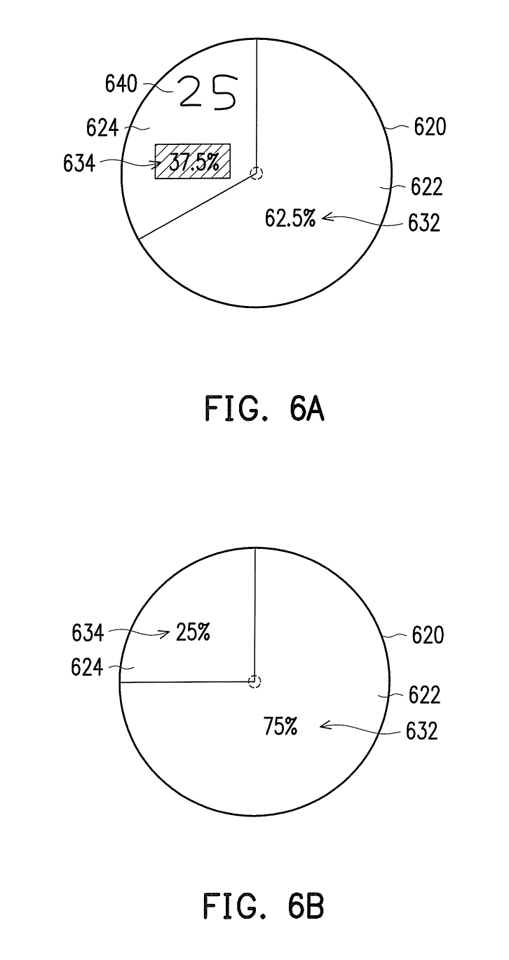

FIG. 6A and FIG. 6B are schematic diagrams illustrating a chart drawing method according to an embodiment of the invention. Referring to FIG. 6A, a chart 620 of the pie chart is divided into an area 622 and an area 624, a text message 632 of the proportion “62.5%” is displayed in the area 622, and a text message 634 of the proportion “37.5%” is displayed in the area 624. First, the user clicks on the text message 634 displayed in the area 624 to trigger the adjusting instruction. The processing unit 110 receives a signal indicating that the text message 634 is clicked to learn that the adjusting instruction has been triggered. For example, the text message 634 is selected by highlight to indicate the text message 634 is in the selected state. Subsequently, the user may write down a text “25” near a circumference in the area 624 to generate a hand-painted trajectory 640 for representing a new proportion of the area 624. After receiving the hand-painted trajectory 640 of the user, the processing unit 110 recognizes and converts the hand-painted trajectory 640 into the digitized text. Subsequently, the processing unit 110 calculates the proportion of each of the areas in the chart 620 according to the text recognized according to the hand-painted trajectory 640, and re-displays the chart 620 in the display unit 120, as shown in FIG. 6B. After the chart 620 of FIG. 6B is re-displayed, the proportion of the area 622 is adjusted to 75% and displayed by the text message 632, and the proportion of the area 624 is adjusted to 25% and displayed by the text message 634.

In another embodiment, the user may click on an intersection between a chart frame and a dividing line-segment to trigger the adjusting instruction, and drag the intersection on the chart frame to serve as the adjusting instruction which instructs to change the proportions of the adjacent areas. After receiving the adjusting instruction, the processing unit 110 may calculate the proportion of each of the areas in the adjusted chart after the adjustment, and re-display the chart in the display unit 120. This will be discussed below with reference to the following embodiment.

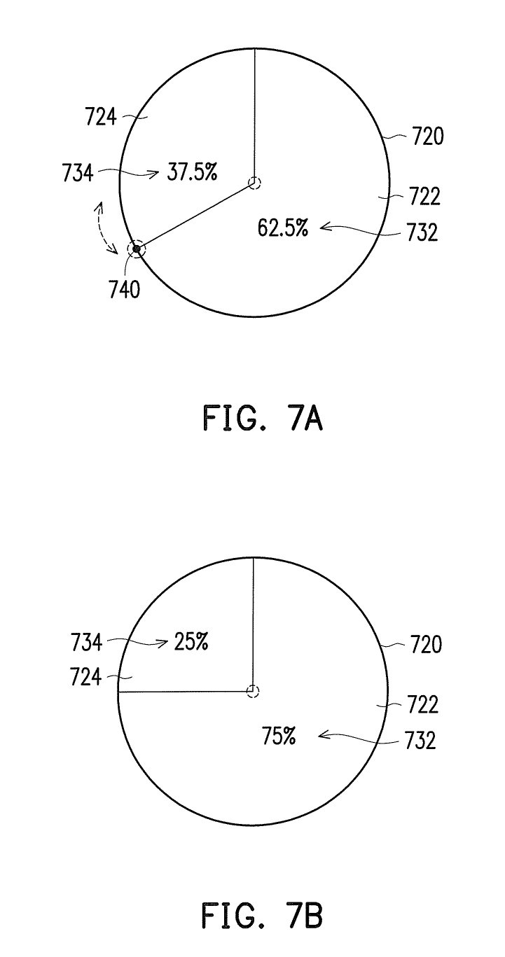

FIG. 7A and FIG. 7B are schematic diagrams illustrating a chart drawing method according to an embodiment of the invention. Referring to FIG. 7A, a chart 720 of the pie chart is divided into an area 722 and an area 724, a text message 732 of “62.5%” is displayed in the area 722, and a text message 734 of “37.5%” is displayed in the area 724 to represent the proportion of each of the areas. First, the user may click on an intersection (e.g., an intersection 740) between a frame and an area-dividing line-segment of the chart 720 to trigger the adjusting instruction. The processing unit 110 receives a signal indicating that the intersection 740 is clicked to learn that the adjusting instruction has been triggered, and changes a displaying state of the intersection 740 in the display unit 120 in order to indicate that the adjusting instruction has been triggered by the user. For example, the intersection 740 is highlighted by a high brightness color, or the dividing line-segment where the intersection 740 is located is highlighted by the high brightness color. Subsequently, the user may drag the intersection 740 on the frame of the chart 720 to adjust the proportions of the area 722 and the area 724 which are adjacent to each other. For example, the intersection 740 is dragged along a circumference of the chart 720. In addition, an adjusting signal may be generated after the user releases the finger or the stylus from the touch unit 130 when the dragging operation is completed. The processing unit 110 may calculate the proportions of the area 722 and the area 724 in the adjusted chart 720 according to the adjusting signal generated by the intersection 740 dragged by the user, and re-display the chart 720 in the display unit 120, as shown in FIG. 7B. After the chart 720 of FIG. 7B is re-displayed, the proportion of the area 722 is adjusted to 75% and displayed by the text message 732, and the proportion of the area 724 is adjusted to 25% and displayed by the text message 734.

Further, a dimension of the chart may be determined according to the first hand-painted trajectory. Specifically, if the user draws a graph having a length of 100 pixels and a width of 100 pixels by using the hand-painted trajectory, after the hand-painted trajectory is recognized, the digitized graph generated by the processing unit 110 may also be maintained to include the length at 100 pixels and the width at 100 pixels (i.e., the dimension of the original hand-painted trajectory is maintained).

Several embodiments are provided below to describe the drawing methods for various charts in more details.

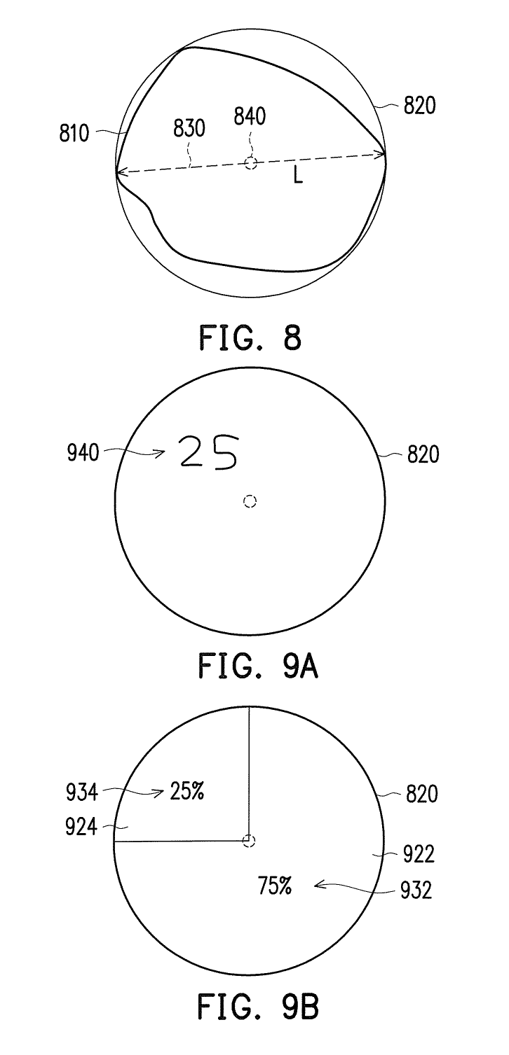

FIG. 8 is a schematic diagram illustrating a pie chart drawing method according to an embodiment of the invention. Referring to FIG. 8, in the present embodiment, after a hand-painted trajectory (the first hand-painted trajectory) 810 of the user is received by the touch unit 130, the processing unit 110 may recognize the predefined chart type corresponding to the hand-painted trajectory 810 as the circle, and the corresponding chart is the pie chart. Subsequently, the processing unit 110 may calculate a length L of a maximum chord 830 of the first hand-painted trajectory 810, and draw a chart 820 by using a center point 840 of the hand-painted trajectory 810 as a circle center and a half of the length L of the maximum chord 830 as a radius.

The method for dividing the chart has been described in details in foregoing embodiments, and thus related description is not repeated hereinafter. However, the user is also able to divide the pie chart into multiple areas by a hand-written value.

FIG. 9A and FIG. 9B are schematic diagrams illustrating a pie chart drawing method according to an embodiment of the invention. Referring to FIG. 9A, the processing unit 110 may receive a hand-written value (hand-painted trajectory) 940 of the user on the chart 820 of the pie chart, and recognize the hand-written value (hand-painted trajectory) 940 as the digitized text “25”. As shown in FIG. 9B, the processing unit 110 divides the chart 820 into an area 922 with the proportion 75% and an area 924 with the proportion 25% according to the digitized text “25”. In FIG. 9B, the chart 820 is re-displayed in the display unit 120, the area 924 including a text message 934 of the proportion “25%” and the area 922 including a text message 932 of the proportion “75%” are divided according to a location of the hand-written value (hand-painted trajectory) 940, and sizes of the areas 922 and 924 are adjusted according to the proportions.

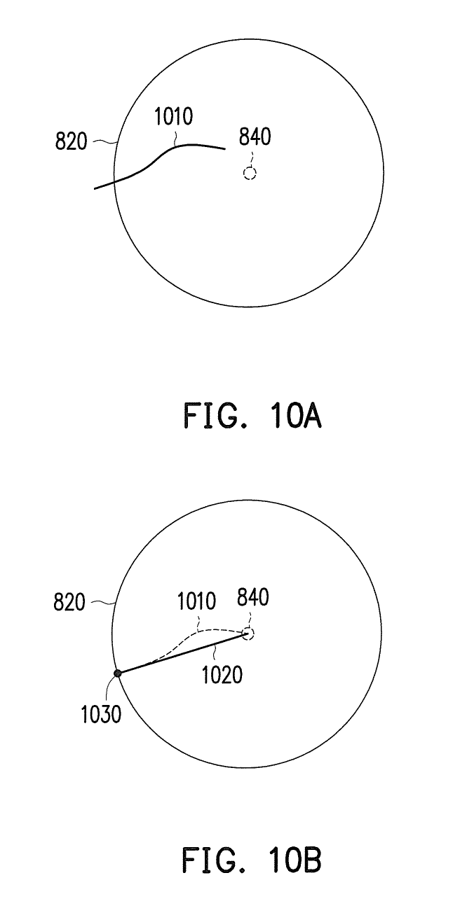

In another embodiment, the user may divide the areas in a manner of hand-writing the line-segments. FIG. 10A and FIG. 10B are schematic diagrams illustrating a pie chart drawing method according to an embodiment of the invention. Referring to FIG. 10A, the user draws a hand-painted trajectory (the second hand-painted trajectory) 1010 on the chart 820 of the pie chart. Referring to FIG. 10B, the processing unit 110 automatically connects two ends of the hand-painted trajectory 1010 together and re-position the two ends onto a circle center 840 and a circumference of the chart 820, respectively. The hand-painted trajectory 1010 is intersected with the circumference of the chart 820 at an intersection 1030. In FIG. 10B, the hand-painted trajectory 1010 illustrated as a dashed line aims to distinguish the hand-painted trajectory 1010 from a radius line-segment 1020 rather than to display the hand-painted trajectory 1010 by using the dashed line. Thereafter, the processing unit 110 displays the radius line-segment 1020 of the chart 820 according to the circle center 840 and the intersection 1030, so that the hand-painted trajectory 1010 is replaced by the radius line-segment 1020 and the hand-painted trajectory 1010 is no longer displayed.

In yet another embodiment, when the processing unit 110 recognizes that the hand-painted trajectory 1010 is located within the chart 820 and the hand-painted trajectory 1010 is a line-segment, the processing unit 110 may determine whether a distance between two ends of the line-segment is greater than a length of a radius of the chart 820. If the distance between the two ends of the line-segment is greater than the length of the radius of the chart 820, a straight line is displayed in the display unit 120 in the chart as the radius of the chart 820 according to a location of the hand-painted trajectory 1010 so as to divide the chart by the straight line, and the hand-painted trajectory 1010 is cleared. If the distance between the two ends is not greater than the radius, the processing unit 110 directly ignores (cancels) the hand-painted trajectory 1010 without performing further actions.

Additionally, if the processing unit 110 determines that the distance between the two ends of the line-segment is greater than the length of the radius of the chart 820, a straight line may also be displayed in the chart as a diameter according to a location of the hand-painted trajectory 1010 so as to divide the chart 820 by the straight line, and the hand-painted trajectory 1010 is cleared. If the distance between the two ends of the line-segment is not greater than the radius, a straight line may be displayed in the display unit 120 in the chart as the radius of the chart 820 according to a location of the hand-painted trajectory 1010 so as to divide the chart by the straight line, and the hand-painted trajectory 1010 is cleared.

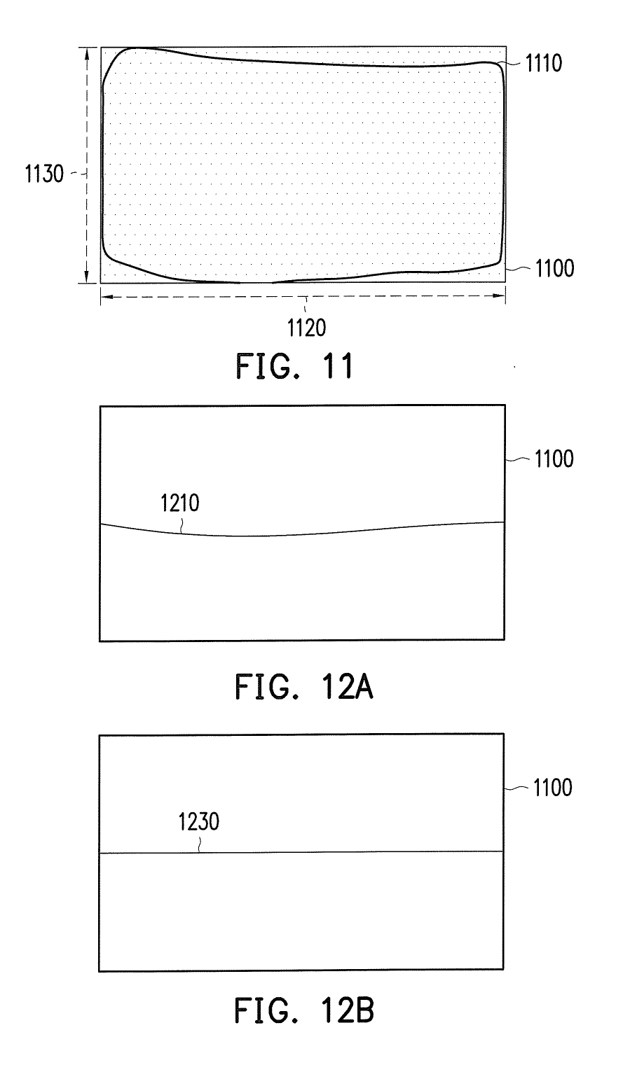

FIG. 11 is a schematic diagram illustrating a table drawing method according to an embodiment of the invention. Referring to FIG. 11, in the present embodiment, after a hand-painted trajectory (the first hand-painted trajectory) 1110 of the user is received by the touch unit 130, the processing unit 110 recognizes and determines the predefined chart type corresponding to the hand-painted trajectory 1110 as the rectangle, and the corresponding chart is the table. Subsequently, the processing unit 110 may calculate a length of a horizontal edge 1120 and a length of a vertical edge 1130 of the hand-painted trajectory 1110, where the horizontal edge 1120 is intersected with the vertical edge 1130. The processing unit 110 draws a chart 1100 according to the length of the horizontal edge 1120 and the length of the vertical edge 1130.

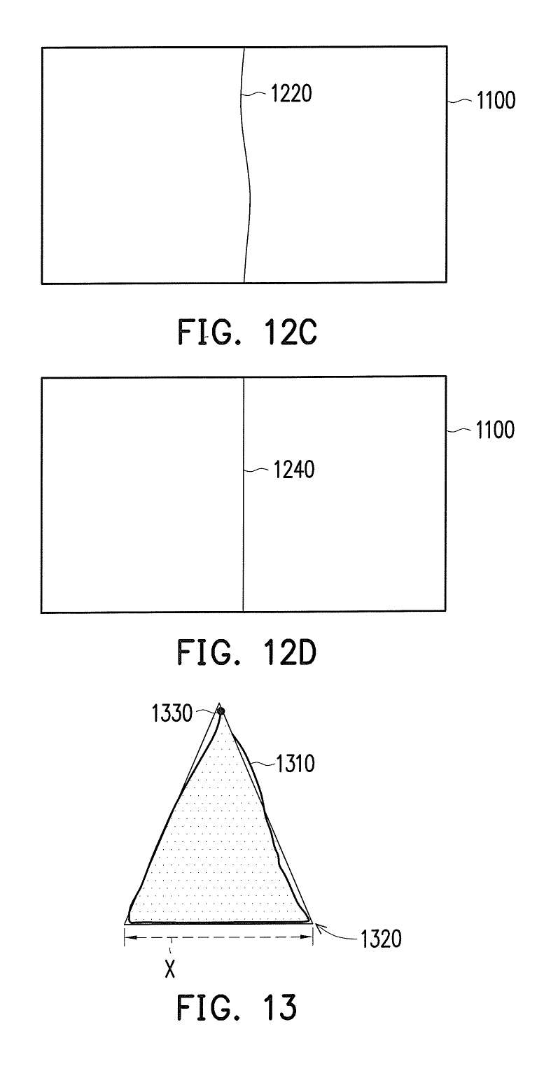

FIG. 12A and FIG. 12B are schematic diagrams illustrating a table drawing method according to an embodiment of the invention. A method for the user to divide the areas of the table is described in details as follows.

Referring to FIG. 12A, when the processing unit 110 determines that a hand-painted trajectory (the second hand-painted trajectory) 1210 is located within the chart 1100 and the hand-painted trajectory 1210 is a horizontal line-segment substantially parallel to a horizontal direction, the processing unit 110 determines whether a length of the horizontal line-segment (e.g., a distance between two ends of the hand-painted trajectory 1210) is greater than a half of the length of the horizontal edge of the chart 1100. If the length of the horizontal line-segment is greater than the half of the length of the horizontal edge of the chart 1100, as shown in FIG. 12B, a horizontal grid line 1230 may be displayed in the chart 1100 in the display unit 120 according a location of the hand-painted trajectory 1210 to thereby divide the chart 1100, and the hand-painted trajectory 1210 is cleared. If the length of the horizontal line-segment (the hand-painted trajectory 1210) is not greater than the half of the length of the horizontal edge of the chart 1100, the hand-painted trajectory 1210 is directly cleared.

Further, referring to FIG. 12C, when the processing unit 110 determines that a hand-painted trajectory (the second hand-painted trajectory) 1220 is located within the chart 1100 and the hand-painted trajectory 1220 is a vertical line-segment substantially parallel to a vertical direction, the processing unit 110 may determine whether a length of the vertical line-segment (e.g., a distance between two ends of the hand-painted trajectory 1220) is greater than a half of the vertical edge of the chart 1100. If the length of the vertical line-segment is greater than the half of the length of the vertical edge of the chart, as shown in FIG. 12D, a vertical grid line 1240 may be displayed in the chart 1100 in the display unit 120 according a location of the hand-painted trajectory 1220 to thereby divide the chart 1100, and the hand-painted trajectory 1220 is cleared. If the length of the vertical line-segment (the hand-painted trajectory 1220) is not greater than the half of the length of the vertical edge of the chart 1100, the hand-painted trajectory 1220 is directly cleared.

By performing aforesaid methods repeatedly, the table 1100 may be divided into multiple fields. After the table is drawn, the user may also click on an empty field to edit the selected field in the hand-writing manner. The processing unit 110 recognizes and converts contents from hand-written contents into the digitized contents, and displays the converted digitized contents in the selected field in the display unit 120.

FIG. 13 is a schematic diagram illustrating a pyramid chart drawing method according to an embodiment of the invention. Referring to FIG. 13, in the present embodiment, after a hand-painted trajectory (the first hand-painted trajectory) 1310 of the user is received by the touch unit 130, the processing unit 110 may recognize the predefined chart type corresponding to the hand-painted trajectory 1310 as the triangle, and the corresponding chart is the pyramid chart. Subsequently, the processing unit 110 may calculate a length of a bottom side of the hand-painted trajectory 1310, calculate a vertex relative to the bottom side in the hand-painted trajectory 1310, and draw a chart 1300 of the pyramid chart by using the bottom side and the vertex. Specifically, the processing unit 110 may draw the chart 1300 of the pyramid chart by using a length X of a bottom side 1320 of the hand-painted trajectory 1310 and a vertex 1330 relative to the bottom side 1320. The method of dividing areas for the pyramid chart is similar to those described in the foregoing embodiments, which is not repeated hereinafter.

In summary, in the chart drawing method of the disclosure, a digitized chart may be drawn by receiving the drawing instruction of the user, recognizing the hand-painted trajectory of the user, and comparing the hand-painted trajectory with the predefined chart type. In addition, the corresponding method for dividing the areas is provided according to the chart type, so that users can draw the chart in an intuitive and convenient manner.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A chart drawing method for an electronic device, comprising:
receiving a drawing instruction, and enabling a drawing operation according to the drawing instruction;
receiving a first hand-painted trajectory, and recognizing whether the first hand-painted trajectory matches a predefined chart type;
displaying a chart corresponding to the predefined chart type and clearing the first hand-painted trajectory when the first hand-painted trajectory matches the predefined chart type; and
receiving a second hand-painted trajectory, and dividing the chart into a plurality of areas according to the second hand-painted trajectory.

2. The chart drawing method of claim 1, further comprising:
calculating a proportion of each of the areas in the chart, and displaying a text message corresponding to the proportion in each corresponding one of the areas.

3. The chart drawing method of claim 1, further comprising:
changing a proportion of each of the areas in the chart according to an adjusting instruction, and re-displaying the chart.

4. The chart drawing method of claim 1, wherein after the step of recognizing whether the first hand-painted trajectory matches the predefined chart type, the chart drawing method further comprises:
displaying a chart menu when there is no predefined chart type corresponding to the first hand-painted trajectory, wherein the chart menu comprises one or more chart options;
receiving a user selection to select one of the one or more chart options; and
displaying the chart according to the selected chart option, and clearing the first hand-painted trajectory.

5. The chart drawing method of claim 1, wherein a dimension of the chart is determined according to the first hand-painted trajectory.

6. The chart drawing method of claim 1, wherein the predefined chart type corresponding to the first hand-painted trajectory is a circle, and the chart corresponding to the circle is a pie chart, wherein the step of displaying the chart corresponding to the predefined chart type further comprises:
calculating a length of a maximum chord of the first hand-painted trajectory, and drawing the chart by using a center point of the first hand-painted trajectory as a circle center and a half of the length of the maximum chord as a radius.

7. The chart drawing method of claim 6, wherein after the step of dividing the chart into the areas according to the second hand-painted trajectory, the chart drawing method further comprises:
receiving a hand-written value, and recognizing the hand-written value as a digitized text; and
adjusting sizes of the areas according to the digitized text.

8. The chart drawing method of claim 6, wherein the step of dividing the chart into the areas according to the second hand-painted trajectory further comprises:
when the second hand-painted trajectory is located within the chart and the second hand-painted trajectory is a line-segment, determining whether a distance between two ends of the line-segment is greater than the radius;
if the distance between the two ends of the line-segment is greater than the radius, displaying a straight line in the chart according to a location of the second hand-painted trajectory to divide the chart by the straight line, and clearing the second hand-painted trajectory; and
if the distance between the two ends of the line-segment is not greater than the radius, directly clearing the second hand-painted trajectory.

9. The chart drawing method of claim 1, wherein the predefined chart type corresponding to the first hand-painted trajectory is a rectangle, and the chart corresponding to the rectangle is a table, wherein the step of displaying the chart corresponding to the predefined chart type further comprises:
calculating a length of a horizontal edge and a length of a vertical edge of the first hand-painted trajectory, wherein the horizontal edge is intersected with the vertical edge; and
drawing the chart according to the length of the horizontal edge and the length of the vertical edge.

10. The chart drawing method of claim 9, wherein the step of dividing the chart into the areas according to the second hand-painted trajectory further comprises:
when the second hand-painted trajectory is located within the chart and the second hand-painted trajectory is a horizontal line-segment, determining whether a length of the horizontal line-segment is greater than a half of the length of the horizontal edge of the chart;
if the length of the horizontal line-segment is greater than the half of the length of the horizontal edge of the chart, displaying a horizontal grid line in the chart according to a location of the second hand-painted trajectory to thereby divide the chart, and clearing the second hand-painted trajectory;
if the length of the horizontal line-segment is not greater than the half of the length of the horizontal edge of the chart, directly clearing the second hand-painted trajectory;
when the second hand-painted trajectory is located within the chart and the second hand-painted trajectory is a vertical line-segment, determining whether a length of the vertical line-segment is greater than a half of the length of the vertical edge of the chart;
if the length of the vertical line-segment is greater than the half of the length of the vertical edge of the chart, displaying a vertical grid line in the chart according to the location of the second hand-painted trajectory to thereby divide the chart, and clearing the second hand-painted trajectory; and
if the length of the vertical line-segment is not greater than the half of the length of the vertical edge of the chart, directly clearing the second hand-painted trajectory.

11. The chart drawing method of claim 1, wherein the predefined chart type corresponding to the first hand-painted trajectory is a triangle, and the chart corresponding to the triangle is a pyramid chart, wherein the step of displaying the chart corresponding to the predefined chart type further comprises:
calculating a length of a bottom side of the first hand-painted trajectory, calculating a vertex relative to the bottom side in the first hand-painted trajectory, and drawing the chart by using the bottom side and the vertex.
